(19) United States
(12) Patent Application Publication
(10) Pub. No.: US 2016/0273567 A1
(43) Pub. Date: Sep. 22, 2016

(54) LATERALLY ELONGATED MITER RIB

(71) Applicant: Todd Joseph Gleason, Howell, NJ (US)

(72) Inventor: Todd Joseph Gleason, Howell, NJ (US)

(21) Appl. No.: 15/075,934

(22) Filed: Mar. 21, 2016

Related U.S. Application Data
(60) Provisional application No. 62/177,551, filed on Mar. 19, 2015.

(51) Int. Cl. F16B 12/22; F16B 12/46

(52) U.S. Cl. CPC F16B 12/22; F16B 12/46

(57) ABSTRACT

A laterally elongated miter rib is used as an internal fastener to attach two mitered members to one another. In the illustrative embodiment, the miter rib has two arms that are substantially orthogonal to one another. Each arm has a surface modification for improving the ability of the arm to grip the sidewalls of slots formed in the members. The arms have a length of around 1 inch, but have a greatly elongated lateral dimension that is typically equal in length to the members being attached thereby.

### STATEMENT OF RELATED CASES

This case claims priority to U.S. Pat. App. Ser. 62/177,551 filed Mar. 19, 2015 and incorporated by reference herein.

### FIELD OF THE INVENTION

The present invention relates generally to the construction arts and more particularly to an article for attaching pieces of material (e.g., wood, engineered lumber, composites, plastic, etc.) to one another, such as to fabricate furniture, etc., or for use as interior/exterior features of buildings or other structures.

### BACKGROUND OF THE INVENTION

When making furniture, picture frames, buildings, and other structures, the members (e.g., pieces of wood, composites, etc.) of the article must be inevitably be joined to one another. This joinder is called a “joint”. There are a variety of different types of joints, each having its own advantages and disadvantages. For example, there are butt joints, dowel joints, rabbet joints, mortise and tenon joints, miter joints, biscuit joints, and dovetail joints, among others.

A miter joint typically joins two members at a 45-degree angle to form a 90-degree corner. The miter joint is useful for concealing the end grain of a piece of lumber and is typically used for frames (e.g., doors, window, picture, etc.), moldings, and cabinets. A draw back to this type of joint is that it is weak unless properly reinforced. With respect to joining mitered pieces of wood, for example, glue tends to set poorly. And reinforcing the glued joint with screws and nails can be problematic because such fasteners might not hold well since they are being sunk into end grain of the wood.

A miter joint can be effectively reinforced by dowels, a notch joint and triangular shim, biscuits, and the like, which can also function as a decorative accent if contrasting wood species are used. However, this approach is more likely to be adopted by a custom woodworker who is doing fine finish work on a home, or a furniture maker who is building custom furniture, than a contractor/subcontractor that is installing moldings or door frames during construction of a tract house.

The prior art is replete with frame-corner fasteners, sometimes referred to as “splines” or “keys,” which are intended to address the issue of how to join mitered edges of various type of frames.

One problem that arises frequently is that of creating a frame from non-wood segments, such as are typically formed from aluminum, steel or composite materials. Examples include: frames for screens (U.S. Pat. Nos. 3,269,455; 6,681,833), screen print frames (U.S. Pat. No. 5,040,456); trim work for cabinets or other structural edges (U.S. Pat. Nos. 3,321,223; 3,467,423); and generic uses (U.S. Pat. Nos. 2,996,159; 3,200,913).

The frame segments of such frames, which are typically hollow, are often formed by rollforming or extrusion. Because the frame segments are hollow, it is desirable that they be attached to one another by miter joints so that the hollow interior of a frame segment is not exposed to view. Since the frame segments are formed of a material other than wood and are hollow, they are not readily attached to one another by glue, screws, or nails.

The prior art addresses this problem with special frame-corner fasteners, typically in the form of an L-shaped “key” or “spline.” The key usually incorporates teeth/serrations, sometimes flexible, that are intended to engage the interior surface of each of adjacent frame segments with sufficient pressure to lock the key to each such segment. This locks adjacent frame segments to one another. Four such keys are used to lock four frame segments together to form a frame.

The prior art has also addressed the problem of creating frames consisting of mitered segments of wood. Typical applications include window casings (U.S. Pat App. Publ. 2012/0240494) and generic uses (U.S. Pat. No. 2,857,635; US 2013/0019558). Although not as problematic as coupling non-wood frame segments, the aforementioned special frame-corner fasteners are often used to improve joint strength.

### SUMMARY OF THE INVENTION

The present invention provides a way to couple structural (or non-structural) members to one another with far less effort and expense than was formerly possible. In accordance with the illustrative embodiment, a laterally elongated miter rib is used as an internal fastener to attach two mitered pieces of material to one another.

In the illustrative embodiment, the elongated miter rib has an “L” shaped cross section wherein two members or arms meet at a ninety degree angle. Each arm is nominally (although not necessarily) the same length, so the “L-shape” characterization is somewhat mis-descriptive. Each arm of the elongated miter rib has a surface modification, which, in the illustrative embodiment, comprises a plurality of small teeth.

In preparation for joining two pieces of material, a slot is formed in a side edge of each piece material, the slot running substantially the full length of the material. The slot can be formed using a table saw, router, etc. In some embodiments, the slot is formed using a specially adapted “toe-kick” saw. The slotted sides are then mitered, such as at 45 degrees. One arm of the laterally elongated miter rib is inserted into the slot in one piece of material and the other arm is inserted into the slot in the other piece of material. Forcing the arms into the two pieces of material draws them together. The surface modification—in the illustrative embodiment, teeth—prevents the two pieces of material from moving apart.

Unlike the frame-corner fasteners of the prior art, the laterally elongated miter rib has a lateral dimension or length of at least 3 inches, and more typically well in excess of 12 inches. Since each “arm” of the L-shaped laterally elongated miter rib has a length of about 1 inch (like prior-art frame corner fasteners), the ratio of the lateral dimension of laterally elongated miter rib to the length of one of its arms is at least about 3:1 and more typically well in excess of 12:1. Most prior-art frame-corner fasteners have a lateral dimension in the range of about ⅛ inch to about ⅜ inch. As such, the ratio of the lateral dimension to the length of one of the arms of a prior-art frame-corner fastener is typically less than 0.5:1.

FIG. 14 depicts frame 1400 assembled using conventional frame-corner fasteners 1404. Frame 1400 consists of four segments 1402A, 1402B, 1402C, and 1402D. Four fasteners 1404 are used to couple the four segments to one another. The segments are depicted slightly spaced apart from one another for pedagogical purposes; the segments would normally tightly abut one another.

FIG. 15A depicts an enlargement of segment 1402D of frame 1400, showing slot 1508A, which is dimensioned and arranged to receive a conventional frame-corner fastener. It is notable that slot 1508A is oriented such that dimension L_{F} of the prior-art frame-corner fastener (which is equivalent to lateral dimension or length L_{M} of a laterally elongated miter rib in accordance with the present teachings) is parallel to thickness T_{b} of segment 1402D.

For comparison, a similar segment 1502D of material is depicted in FIG. 15B. Segment 1502D includes slot 1508B, which is dimensioned and arranged to receive a laterally elongated miter rib in accordance with the present teachings. Note that slot 1508B is oriented so that lateral dimension L_{M} of the miter rib is parallel to the length of L_{b} of segment 1502D. Thus, a conventional frame-corner fastener has a lateral dimension consistent with the thickness of the frame segment. By contrast, a laterally elongated miter rib has a lateral dimension consistent with the length of the boards being coupled together.

In accordance with the present teachings, there is no limit to the lateral dimension of the laterally elongated miter rib. Subject to aesthetic considerations, the lateral dimension or length of the laterally elongated miter rib is equal to the length of each of the members that are being joined to one another via the rib.

For example, consider a scenario in which four pieces of 1″×6″ material (e.g., wood, composite, etc.) that are each 8 feet long (i.e., nominal ceiling height) are used to “box” in a lally column (i.e., structural steel columns filled with concrete, often located in a basement, for providing support to overlying beams). In accordance with the present teachings, four laterally elongated miter ribs each having a lateral dimension of about 8 feet are advantageously used. Assuming that each arm of the laterally elongated miter rib is 1 inch, the ratio of the length of the miter rib to the length of its arm is about 96:1.

If the members being joined are of unequal length, the laterally elongated miter rib will typically be no longer than the length of the shorter member. In embodiments in which aesthetics or other considerations dictate that the laterally elongated miter rib remain concealed when in use, the length of the miter rib should be at least about 10 millimeters shorter than the members being joined. In a typical application, the length of a laterally elongated miter rib in accordance with the present teachings will usually be at least 90 percent of the length of the members being joined.

In some embodiments, several shorter-length laterally elongated miter ribs can be used rather than a single, relatively longer laterally elongated miter rib. In such embodiments, the collective length of the laterally elongated miter ribs will typically be at least 75 percent of the length of the members being attached, since there can be gaps between successive miter ribs.

The laterally elongated miter rib provides new solutions to design and building challenges. For example, it is desirable when finishing the basement of a home to hide the lally columns In the prior art, this is often accomplished by boxing in the columns using sheetrock. This is a fairly laborious process, which requires creating some form of wooden skeletal structure around the column and then attaching four appropriately sized and cut pieces of sheet rock. Lengths of corner bead are applied, from floor to ceiling, at each of the four corners of the box. Multiple coats of spackle, with intervening sanding, is then applied to cover the corner bead and the depressions formed in the sheetrock caused by the screws that attach it to the underlying wood structure.

In accordance with the present teachings, a similar box can be created using four laterally elongated miter ribs. A slot is formed into each of the two side edges of four pieces of appropriately sized material (wood, composite, etc.). The slot can be formed with a table saw, router, etc., or the specially adapted toe-kick saw. Those same side edges are then mitered. Two of the laterally elongated miter ribs are inserted into the two slots formed in opposite edges of one piece of the material. Two pieces of the material are then coupled to the first piece by inserting the exposed arm of each miter rib into one of the slots of each of the pieces. What results is a partially formed (three sides) of a rectangular box having a length equal to that of the lally column. The partially completed box is positioned around the lally column and the remaining two miter ribs are inserted into exposed edges of the partially formed box. The remaining piece of material is then moved into place, each edge receiving an exposed arm of the miter ribs. Once all four pieces of material are coupled, the pieces are snugged up and a virtually seamless enclosure with no exposed fasteners results.

In similar fashion, the lateral elongated miter ribs can be used to form a box, a pedestal, etc., with no exposed fasteners.

The laterally elongated miter rib can be used to great advantage on construction sites for joining long pieces of wood of composite material that, when coupled together, are oriented orthogonally to one another. This arrangement often arises at various “overhang” locations at the perimeter of the house wherein a sidewall meets a roof, etc. Other applications include:
audio/electric/plumbing chases;
coffered ceilings;
soffits;
thin partition panels;
uses in finish construction, such as:
   fastening mitered edges on some of the non-glueable plastics used in the manufacturing of mitered outdoor furniture;
   trimwork;
   free standing mitered backsplashes;
   the manufacture of mitered cabinetry, podiums, vitrines, etc.

### BRIEF DESCRIPTION OF THE DRAWINGS

FIG. 1A depicts an end view of a laterally elongated miter rib in accordance with the illustrative embodiment of the present invention.

FIG. 1B depicts an end view of an exemplary design the laterally elongated miter rib, identifying various dimensions thereof.

FIG. 2 depicts a perspective view of the laterally elongated miter rib of FIG. 1.

FIG. 3 depicts two boards that are to be attached together at their edges such that, when attached, the pieces meet at a right angle.

FIG. 4 depicts a slot formed in an edge of each board shown in FIG. 3, wherein the slotted edge is mitered.

FIG. 5 depicts the two boards shown in FIG. 4, but now attached using the laterally elongated miter rib in accordance with the present invention.

FIG. 6 depicts an arrangement for boxing in a column using laterally elongated miter ribs in accordance with the present invention.

FIG. 7 depicts a conventional toe-kick saw.

FIG. 8 depicts a three-quarter's perspective view of a modified toe-kick saw.

FIG. 9 depicts the modified toe-kick saw of FIG. 8 oriented for use.

FIG. 10 depicts a bottom view of the modified toe-kick saw of FIG. 8.

FIG. 11 depicts a perspective view of the modified toe-kick saw of FIG. 8.

FIG. 12 depicts a side view of the modified toe-kick saw of FIG. 8.

FIG. 13 depicts a side view of the modified toe-kick saw of FIG. 8.

FIG. 14 depicts a frame assembled in accordance with prior-art fasteners.

FIG. 15A depicts detail of one of the frame members of FIG. 14, showing a slot for receiving the prior art fastener.

FIG. 15B depicts detail of a board, showing a slot for receiving a laterally elongated miter rib in accordance with the present teachings.

### DETAILED DESCRIPTION

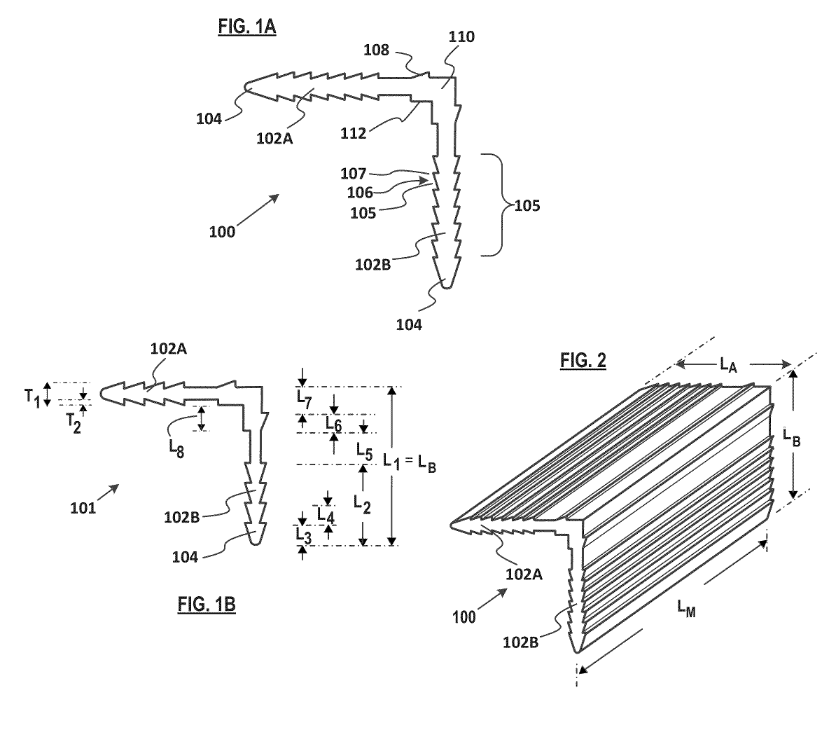

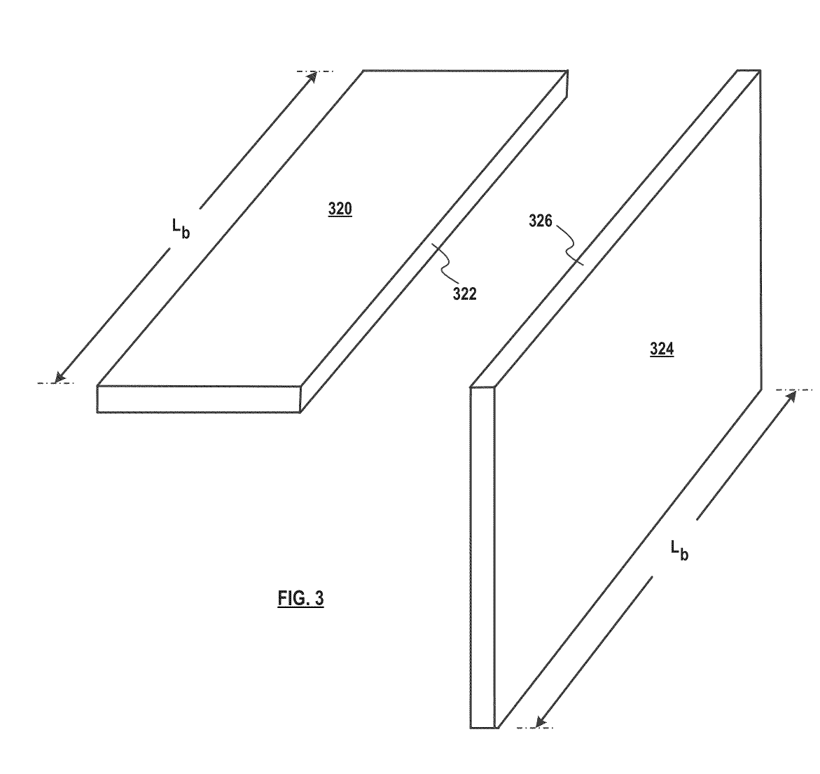

FIG. 1A and FIG. 2 depict respective end and perspective views of laterally elongated miter rib 100 in accordance with the illustrative embodiment of the present invention. Laterally elongated miter rib 100 is a fastener for joining two pieces of materials.

Laterally elongated miter rib 100 comprises arms 102A and 102B. In the illustrative embodiment, arms 102A and 102B (hereinafter collectively “arms 102”) are orthogonally disposed with respect to each other such that their intersection 110 forms a ninety-degree angle. However, in some other embodiments, intersection 110 of arms 102 forms an angle that is other than (i.e., greater than or less than) ninety degrees. In most applications, the angle will not deviate by more than +/−15 degrees; however, greater or less angles are acceptable. The arms 102 are nominally, although not necessarily, the same length; that is, L_{A}=L_{B} (FIG. 2).

Free end 104 of each of arms 102 includes one or more physical adaptations that facilitate inserting the arm into a slot that is formed in a piece of material (e.g., wood, MDF, plastic, etc.). In the illustrative embodiment, one physical adaptation is that each arm terminates with a tapered profile that narrows towards the end of the arm (i.e., an “arrow-head” shape). A second physical adaptation is that end 104 terminates in a somewhat rounded surface, rather than a sharp edge, so that end 104 does not “catch” or “dig in” to the sidewalls of the slot as it is being inserted therein.

At least a portion of each of arms 102 includes surface modification 105 that is physically adapted to grip the sidewalls of the slot into which the arm is inserted. In the illustrative embodiment, surface modification 105 is the presence of a plurality of small teeth or serrations 106. The teeth are oriented so that they provide relatively little resistance to insertion of arms 102, but attempts to withdraw the arms meet relatively increased resistance. This is differentiated response is accomplished, for example, by tapering (i.e., narrowing) leading surface 105 in the forward direction (i.e., towards end 104) but not tapering trailing surface 107.

That is, a given tooth 106 begins with an abrupt increase in width relative to the width of the forward-most edge of the tooth “behind” it. See, e.g., FIG. 1B, wherein the forward-most edge of each tooth 106 has a width of T₁−2(T₂), whereas the trailing edge of each tooth has a width of T₁. As a consequence of this relatively abrupt increase in width (in some embodiments, a step change) between adjacent teeth, trailing surface 107 has a flat face, substantially lacking any taper. Thus, for an arm 102 being withdrawn from a slot, the flat face of trailing surface 107 of each tooth 106 will present relatively increased resistance to movement. Although such resistance can be overcome, it substantially prevents any loosening of the arms 102 of miter rib 100 in the absence of a significant force (e.g., a person pulling the arm from the channel).

In typical embodiments, teeth 106 all have the same length (see FIG. 1B: dimension 14), which length is usually in a range from about 1.5 to 3.5 millimeters. By way of illustration, not limitation, the forward taper provides a reduction in the width of teeth 106 by an amount in the range of about 25 to about 50 percent. In some embodiments, teeth 106 have a moderate rearward taper, as opposed to having a flat face as in the illustrative embodiment. This can result from the manufacturing process itself. It is to be understood that although seven teeth 106 are depicted in the illustrative embodiment, in some other embodiments, a laterally elongated miter rib in accordance with the present teachings will have more than seven teeth 106. And in still further embodiments, a laterally elongated miter rib in accordance with the present teachings will have less than seven teeth 106.

In some other embodiments, surface modification 105 is embodied as other configurations of surface irregularities that improve the grip between one or both of arms 102 of the miter rib and the sidewalls of the slot into which the arm is inserted. For example, in some embodiments, some or all of the surface of arms 102 can be covered with small cylindrical or conical shaped protrusions. In some further embodiments, a high-friction surface coating can be applied to the surface of arms 102 of the miter rib. Other surface modifications, as will occur to those skilled in the art after reading the present disclosure, may suitably be used as well.

Each arm 102 of laterally elongated miter rib 100 includes a second surface modification—surface modification 108—that is physically adapted to improve the grip between the arms of the miter rib and the side walls of the slots into which the arms are inserted. In the illustrative embodiment, surface modification 108 is a tooth or serration similar to teeth 106, wherein the surface modification is near junction 110 of the two arms 102. Thus, when the miter rib is inserted in a slot, surface modification 108 will keep the arm tightly bound to sidewall of the slot near the mouth of the slot. This helps to keep the two pieces of material (that are being joined) tight to one another. In the illustrative embodiment, the surface modification is only present on the outward facing surface of each arm 200 near to inter. The complementary portion 112 of the inward facing surface of each arm is smooth/featureless.

In some other embodiments, surface modification 108 is embodied as other configurations of surface irregularities that improve the grip between one or both of arms 102 of the miter rib and the sidewalls of the slot into which the arm is inserted, as mentioned above in conjunction with the discussion of the surface modification 105. In the illustrative embodiment, surface modifications 105 and 108 are identical to one another (i.e., teeth); however, in some other embodiments, surface modification 105 and surface modification 108 are different from one another.

The maximum width T₁ of the arms 200 is substantially equal to the size of the slot formed in the material to be joined. Typically, width T₁ is in the range of about 2.5 mm to about 3.2 mm (about ⅛ inch), but this width can of course be smaller or larger per application specifics.

With reference to FIG. 2, the lateral dimension or length L_{M} of laterally elongated miter rib 100 is greater than the length L_{A} or L_{B} (collectively length “L”) of its arms 102A or 102B, respectively. Arms 102 typically have a length L of about 25 millimeters (mm) (about 1 inch). Length L_{M} of laterally elongated miter rib 100 is at least 76 mm (about 3 inches) and more commonly much larger than 305 mm (about 12 inches), as a function of the length of the materials being connected thereby. As a consequence, the ratio of the lateral dimension L_{M} of laterally elongated miter rib to the length L_{A} or L_{B} of one of its arms is at least about 3:1 and more typically well in excess of that. Most prior-art frame-corner fasteners have a lateral dimension in the range of about 3.2 mm to about 9.5 mm and the arms are about 25 mm in length. Thus, for prior-art frame-corner fasteners, the aforementioned ratio is always less than 1:1 and usually about 0.125:1.

In some embodiments, laterally elongated miter rib 100 is formed by extruding aluminum. The extrusion die is configured to provide, as appropriate, the various surface modifications previously disclosed. In some further embodiments, the laterally elongated miter rib is formed by extruding any of various polymers that are substantially rigid after extrusion and curing, as required. In some other embodiments, steel can be rolled and then worked (i.e., punched, etc.) to form surface modifications 105, 108. In still further embodiments, laterally elongated miter rib 100 can be “printed” via a 3D printer using suitable polymeric materials or metals. In conjunction with this disclosure, it is within the capabilities of those skilled in the art to select suitable materials (e.g., polymers, etc.) to create laterally elongated miter rib 100 via extrusion or 3D printing techniques.

FIGS. 3 through 5 depict a sequence in which two pieces of material are prepared for use with laterally elongated miter rib 100 and then joined therewith. FIG. 3 depicts boards 320 and 324 prior to processing. The boards are characterized by identical lengths L_{b}. Board 320 has edge 322 along its length; board 324 has edge 326 along its length.

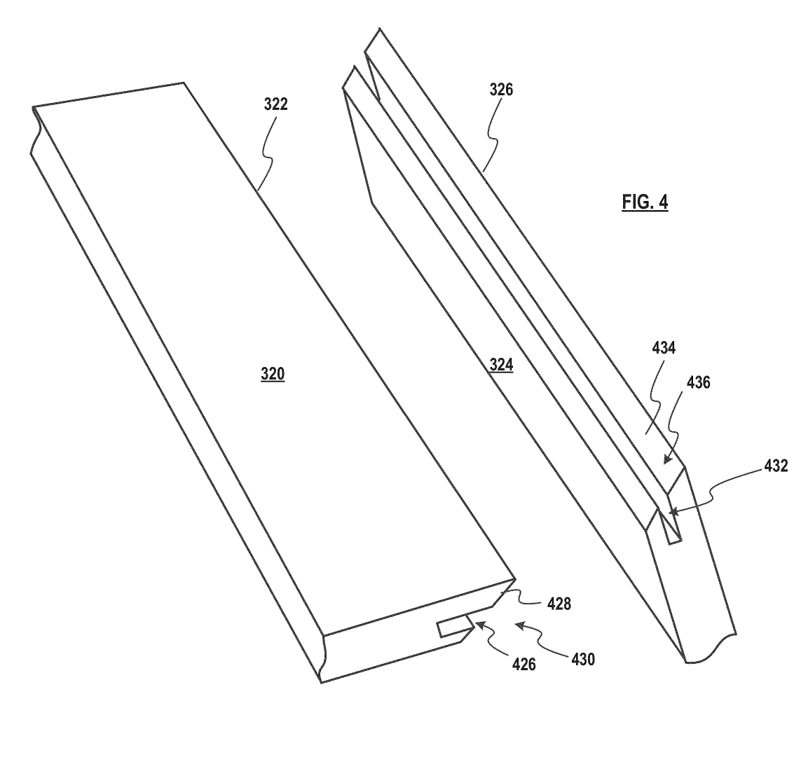

FIG. 4 depicts boards 320 and 324 after a slot or slot has been formed inward from respective edges 322 and 326 and after those edges have been mitered (i.e., cut at an angle). Typically, the slot is formed first and then the edge is mitered.

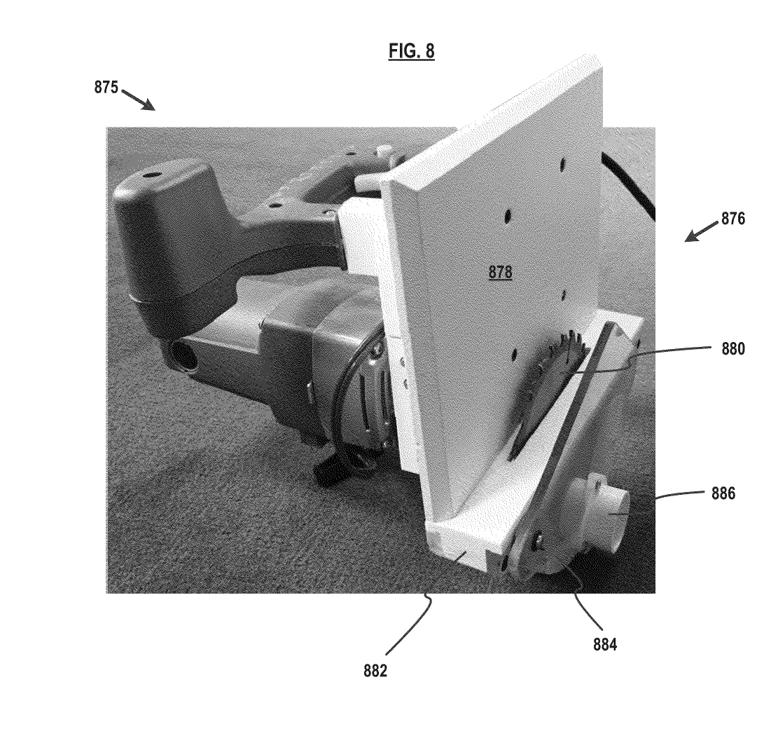

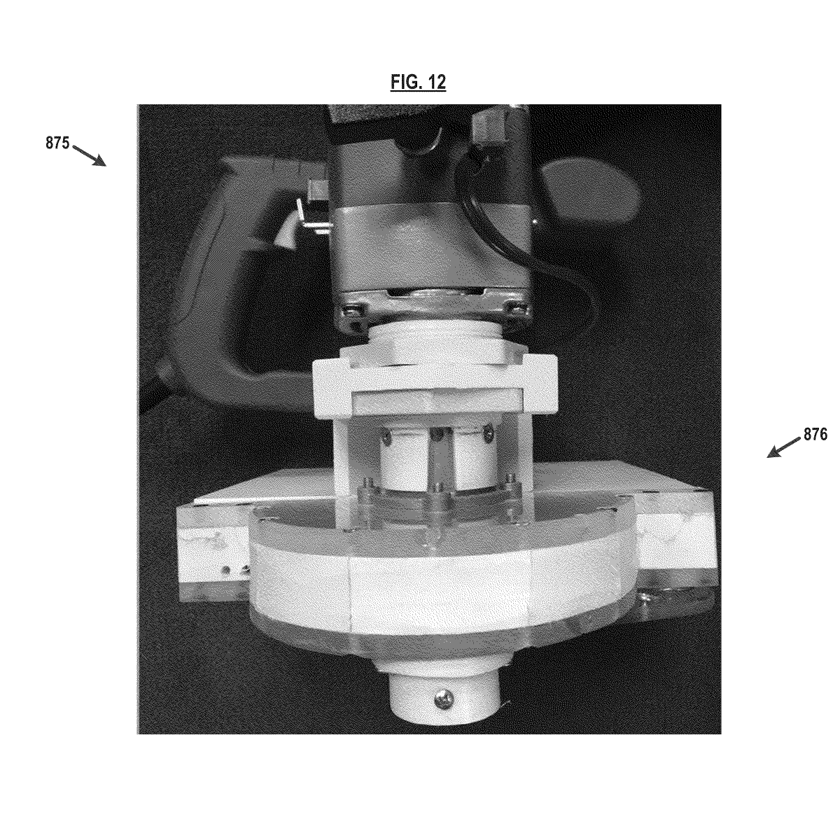

In particular, slot 426 is formed in edge 322 of board 320. The slot can be formed via a router, a table saw, or a modified toe-cut saw discussed later in conjunction with FIGS. 8-12. Edge 322 is mitered to form mitered edge 430, which is defined by surface 428. Slot 432 is formed in edge 326 of board 324. That edge is mitered to form mitered edge 436, which is defined by surface 434. Although the miter is depicted as being close to 45 degrees in this example, the miter cut can be at other angles, as well.

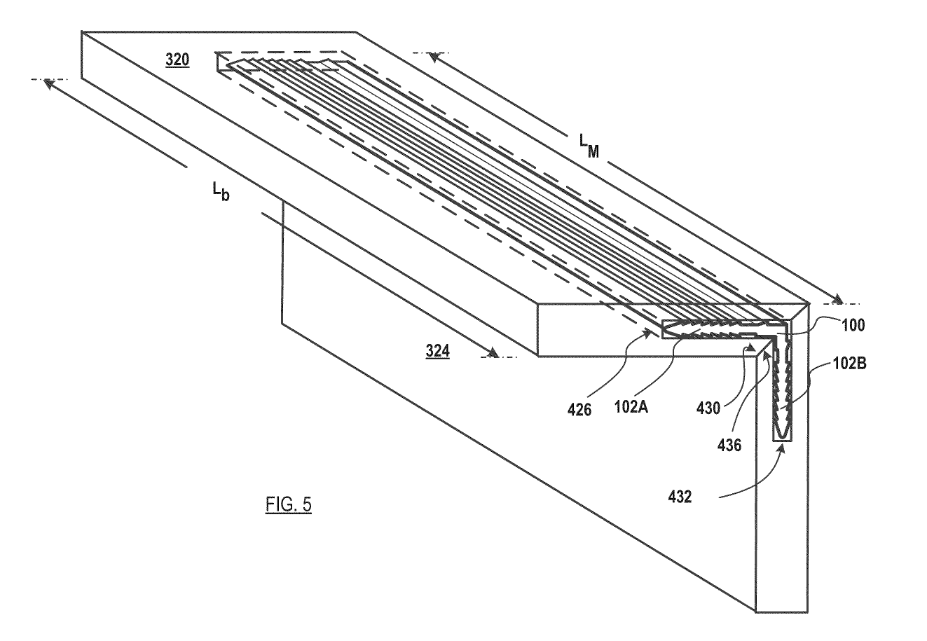

FIG. 5 depicts arm 102A of laterally elongated miter rib 100 disposed in slot 426 of board 320 and arm 102B disposed in slot 432 of board 324. The presence of arms 102 in the slots draws the boards together, such that mitered edge 430 of board 320 and mitered edge 436 of board 432 abut one another. Teeth 106 on the surface of arms 102 of the miter rib bite into the slot walls, preventing boards 320 and 326 from moving apart.

In the embodiment depicted in FIG. 5, the orientation of slots 426 and 432 in the respective boards 320 and 324 is such that when the boards are abutted for joining, the slots will be orthogonal with respect to one another (i.e., form a 90° angle). Consequently, the miter rib used for this embodiment should be appropriately configured (i.e., the two arms 102A and 102B of should be orthogonal with respect to one another).

In the embodiment depicted in FIG. 5, laterally elongated miter rib 100 has a length L_{M} that is equal to length L_{b} of boards 320 and 324. This should occur only for applications in which it is (aesthetically) acceptable for the ends of miter rib 100 to be visible at edges of the boards. In applications in which the miter rib is to remain obscured from view, then miter rib, and the slots in which it resides, must be slightly shorter than the length of the boards being attached (unless the exposed edges will be capped or otherwise obscured).

Laterally elongated miter rib 100 is particularly useful in residential construction, such as, for example, for enclosing “lally columns” as used in basements to support beams, etc. Currently, to enclose a lally column, a contractor will typically cut four pieces of sheet rock, position them around the column, apply corner bead at each corner, tape and repeatedly spackle and sand to form an enclosure. Using the miter rib, four pieces of material are sized, slots are formed in the long edges thereof and then mitered, and a miter rib is inserted at each junction.

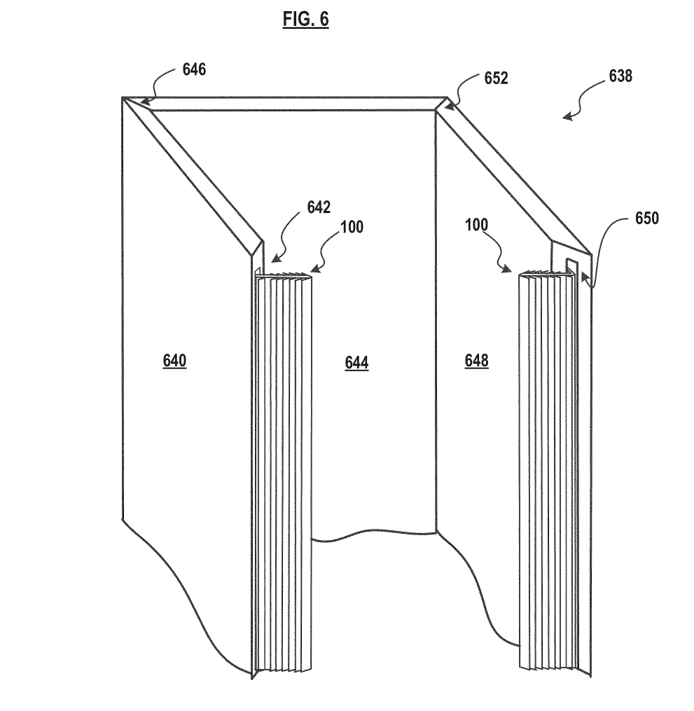

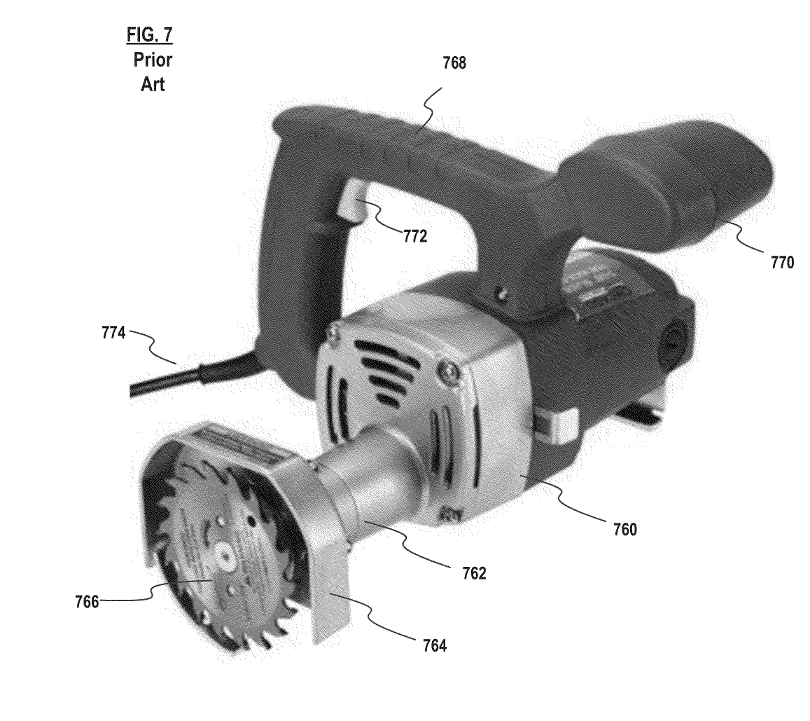

In fact, having knowledge of the length of a lally column, three sides of the enclosure can be formed ahead of time and positioned around a lally column. A portion of three-side preassembly 638 is depicted in FIG. 6 (tally column not shown for clarity).

Preassembly 638 includes three boards 640, 644, and 648. Mitered joint 646 attaches board 640 to board 644 and mitered joint 652 attaches board 644 to board 648. Mitered joint is formed by slotting and mitering what will become the abutting edges of adjacent boards and inserting the arms 102 of laterally elongated miter rib 100 into the slots. The miter rib attaching board 640 to board 644 and the miter rib attached board 644 to board 648 are completely obscured.

Mitered and slotted edge 642 of board 640 has one arm of miter rib 100-1 inserted into the slot and one arm extending therefrom. Similarly, mitered and slotted edge 650 of board 648 has one arm of miter rib 100-2 inserted into the slot and one arm extending therefrom.

To finish the enclosure, a fourth board (not depicted) is simply moved into position such that a slot formed on the “left” edge of the fourth board receives the exposed arm of miter rib 100-1 and a slot formed on the “right” edge of the fourth board received the exposed arm of miter rib 100-2. As will be appreciated by those skilled in the art, it is advantageous for the other miter joints to remain loose until the fourth side is engaged to the miter ribs. Then, the four pieces are pressed together, tightening up the enclosure. The enclosure requires no finishing to cover nails, screws, seams, etc.

### Example

An exemplary design of embodiment 101 of a laterally elongated miter rib in accordance with the present teachings is provided below, with reference to FIG. 1B. Rather than the seven teeth 106 depicted in miter rib 100 depicted in FIG. 1A, the miter depicted in FIG. 1B includes four teeth 106. The laterally elongated miter rib can be formed, for example, by extruding a piece of aluminum.

L₁ = 25 mm
L₂ = 10 mm
L₃ = 3.2 mm
L₄ = 3.2 mm
L₅ = 5 mm
L₆ = 3.2 mm
L₇ = 4 mm
L₈ = 4 mm
T₁ = 3.5 mm
T₂ = 0.75 mm
L_{M} = 2 meters

It was previously noted that a modified toe-kick saw could be used form creating slots to receive laterally elongated miter rib 100. FIG. 7 depicts a conventional toe-kick saw, such as is available from Chicago Electric Power Tools, Crain Tools of Milpitas, Calif., and others. A toe-kick saw is conventionally used for cutting flush up to a wall or baseboard, under kitchen cabinets, so that the cabinets do not have to be moved to remove the flooring underneath. Salient features of the toe-kick saw depicted in FIG. 7 include motor/power unit 760, extended spindle 762, blade guard 764, blade 766, dual handle 768, 770, power trigger 772, and power cord 774.

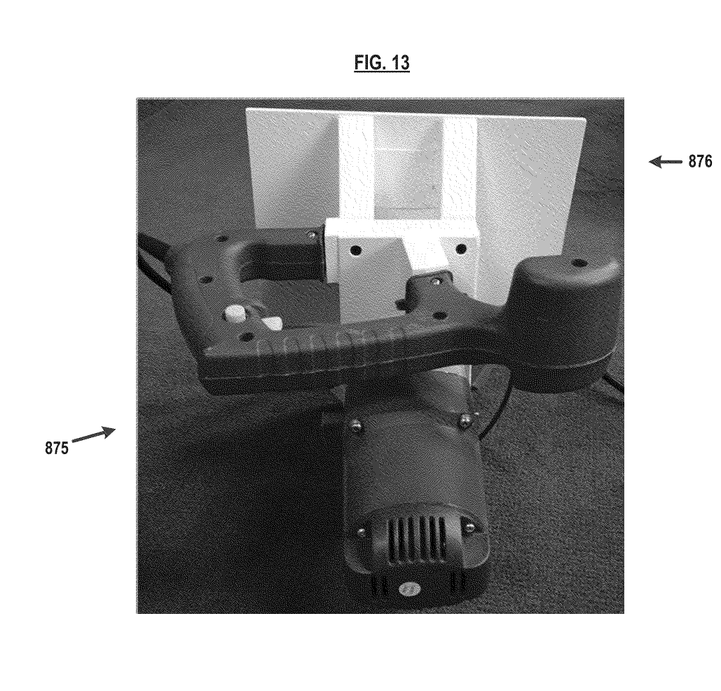

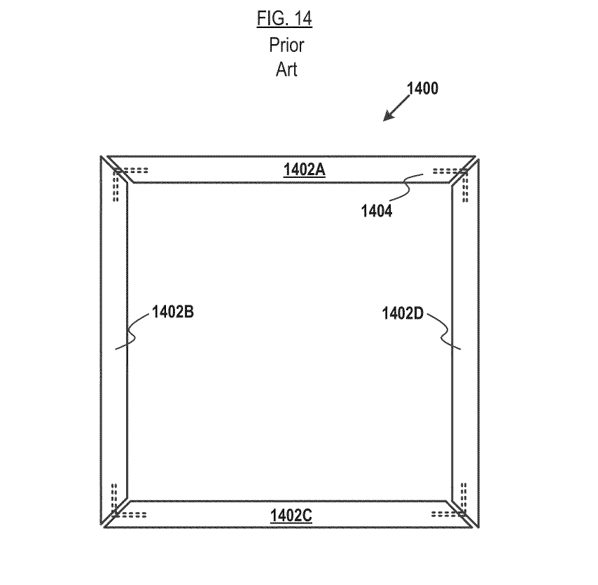

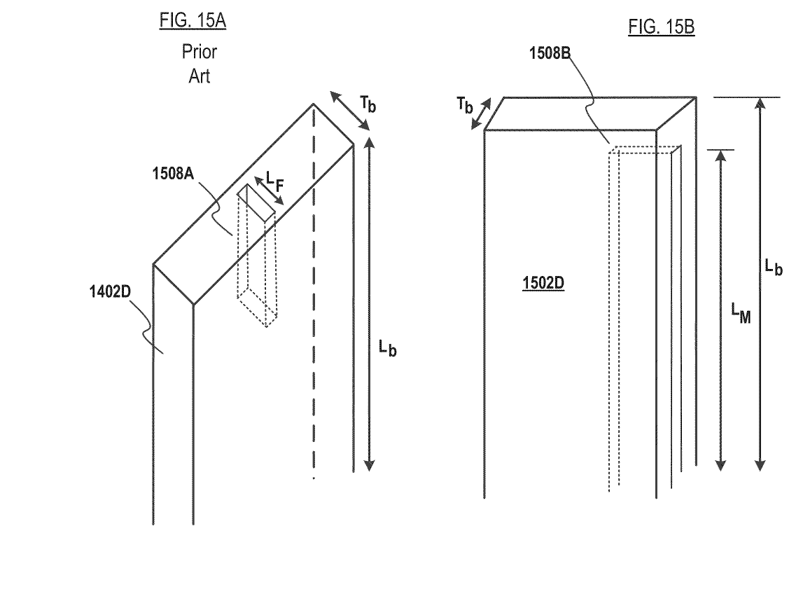

A key features of the toe-kick saw is extended spindle 762, which enables the blade to be set off from the power unit of the saw. It is the extended spindle that makes the toe-kick saw well suited to modification for use in conjunction with embodiments of the present invention. This can be appreciated, for example, with reference to FIGS. 8 through 13, which depict modified toe-kick saw 875. With reference to FIG. 8, the modified toe-kick saw includes slotting system 876, which includes, among other elements pictured, adjustable fence 878, blade platform 882, blade-guard 884, vacuum clean-out 886. Saw blade 880 protrudes through a slot in the blade platform 882. The extended spindle of the conventional toe-kick saw offsets the blade from the power unit of the saw, enabling fence 878 and other elements of slotting system 876 to be positioned around blade 880.

Furthermore, and importantly, if the conventional toe-kick saw were to be used in the position required to cut a slot for use in conjunction with embodiments of the invention (i.e., blade in a horizontal orientation rather than a vertical orientation), the weight of the power unit/motor would not be over the material being slotted. This would make the tool awkward to use. As a consequence, the motor was repositioned (partially rotated) 180 degrees to position the weight over the material being worked.

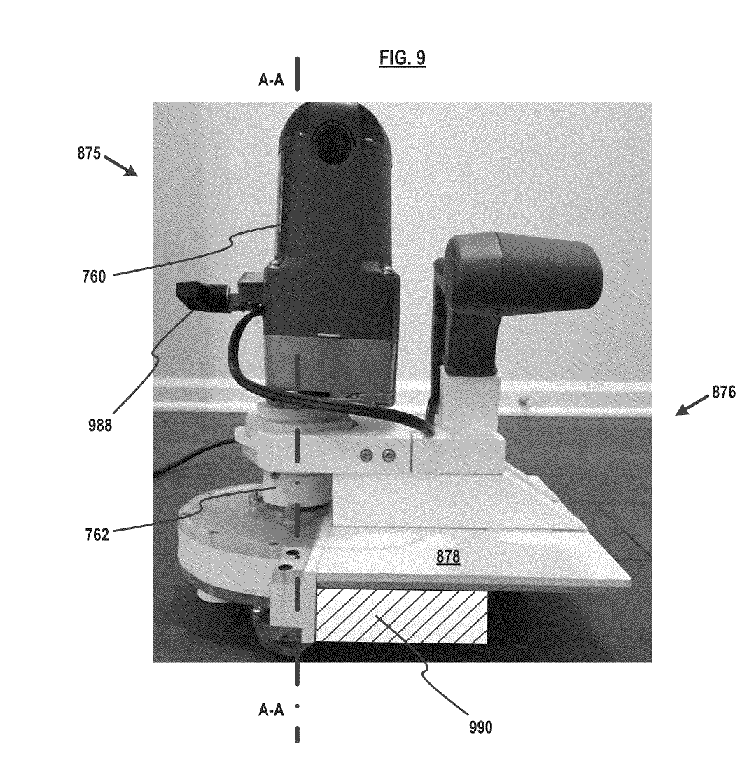

The location of motor/power unit 760 with respect to piece of material be slotted can be best appreciated by viewing FIG. 9. Modified toe-kick saw 875 is depicted in an operating orientation creating a slot in board 990. The saw's blade (not visible in FIG. 9) is projecting horizontally some distance into the “left” edge of board 990, creating a slot (not visible). It is notable that extended spindle 762 is offset with respect to the center of motor/power unit 760. From the perspective shown in FIG. 9, extended spindle 762 is offset to the “left” side of motor/power unit 760. As depicted in FIG. 9, this offset location results in the preponderance of the weight of motor/power unit 760 being located on the “right” side of axis A-A and positioned over board 990. As previously noted, the motor was partially rotated 180 degrees from its position in a conventional toe-kick saw. Thus, in a conventional toe-kick saw, the extended spindle would be offset to the “right” side of motor/power unit 760 and the preponderance of the weight of motor/power unit 760 would be to the “left” of axis A-A. In terms of the manner in which modified saw 865 is used, if the weight were to the “left” of axis A-A, the tool would be unbalanced in use. Handle 988 is also part of slotting system 876; that is, it is one of the modifications made to a conventional toe-kick saw.

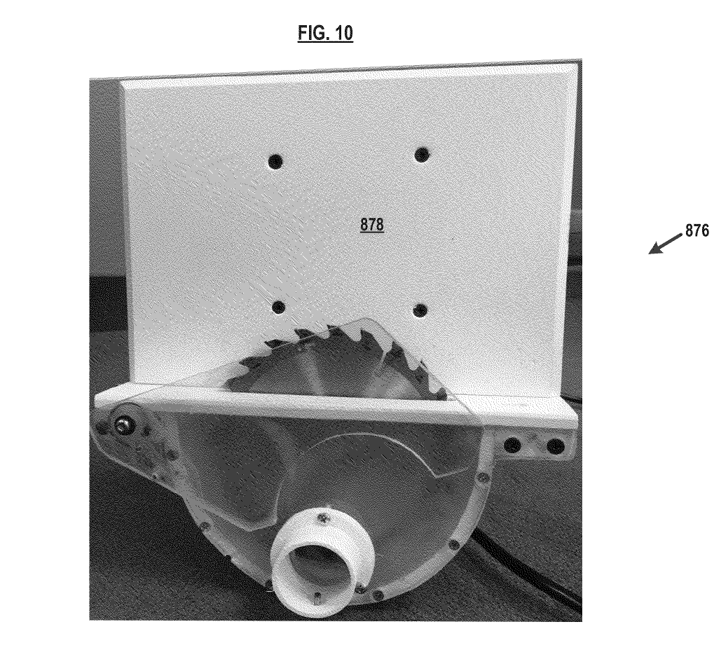

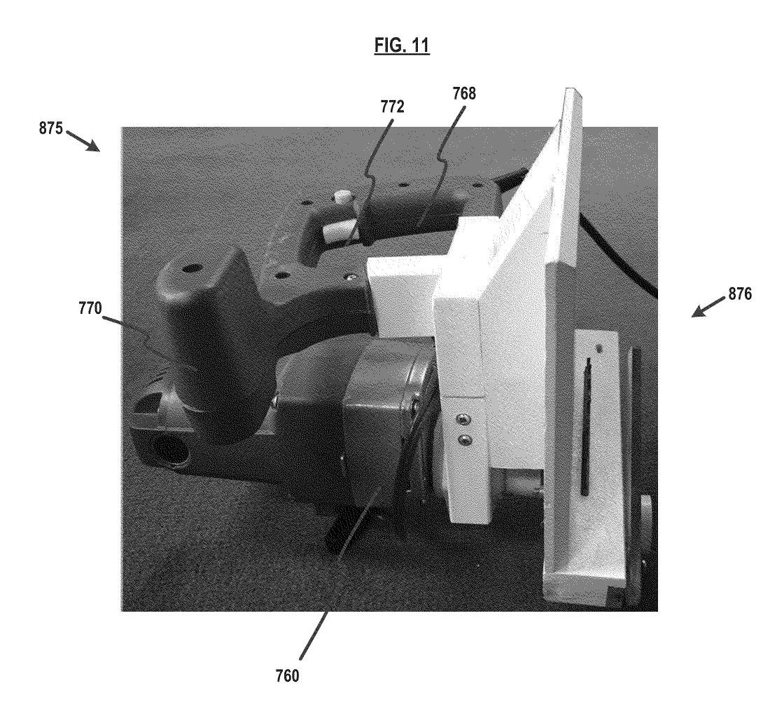

Other elements of the slotting system 876 are depicted in FIGS. 10-13 and will be recognizable/understandable to those skilled in the art.

Slotting system 876 enables the modified toe-kick saw to be used like a highly portable and miniaturized table saw. Since the saw is being used to cut a slot along the length of a board, etc, that is likely to be quite long (e.g., 2 to 4 meters or more), it is important that the board is stable while the slot is being formed so that the slot is straight over its length. The reason for this is that laterally elongated miter rib 100 is likely to be relatively inflexible. Therefore, even minor deviations in the course of the slot, which is very narrow, will make it very difficult or impossible to insert an arm 102 of miter rib 100 into the slot. Thus, the presence of fence 878 and blade platform 882 (and balance due to the re-positioned motor/power unit) provide the requisite stability.

To accommodate slotting system 876, handle 768 of the conventional toe-kick saw must be repositioned; the new position is depicted in the FIGS. 8-9 and 11-13, with elements of handle 768, such as trigger 772 and offset handle 770, identified in FIG. 11.

It is to be understood that the disclosure teaches just one example of the illustrative embodiment and that many variations of the invention can easily be devised by those skilled in the art after reading this disclosure and that the scope of the present invention is to be determined by the following claims.

I claim:

1. A laterally elongated miter rib for use in joining a first member and a second member to one another, the laterally elongated miter rib comprising:
a first arm, the first arm having an outward-facing surface and an inward-facing surface, wherein both said surfaces of the first arm have a first surface modification that increases a grip between the first arm and a slot in the first member in which the first arm is disposed when the laterally elongated miter rib is in use, the first arm further having a second surface modification on at least the outward-facing surface thereof; and
a second arm, the second arm having an outward-facing surface and an inward-facing surface, wherein both surfaces of the second arm have a first surface modification that increases a grip between the second arm and a slot in the second member in which the second arm is disposed when the laterally elongated miter rib is in use, the second arm further having a second surface modification on at least the outward-facing surface thereof, wherein:
(i) the first arm and the second arm are each characterized by a first end and a second end,
(ii) the first arm and the second arm intersect one another at the respective first ends thereof,
(iii) the first arm has a first length measured between the first end and the second end thereof and the second arm has a second length measured between the first end and the second end thereof,
(iv) the first arm and the second arm have a lateral dimension that defines the length of the laterally elongated miter rib, and
(v) a ratio of the length of the laterally elongated miter rib to the first length of the first arm is at least 3:1.

2. The laterally elongated miter rib of claim 1 and further wherein the first surface modification comprises a plurality of serrations.

3. The laterally elongated miter rib of claim 1 and further wherein the second surface modification comprises a plurality of serrations.

4. The laterally elongated miter rib of claim 1 wherein the first member has a length and further wherein the length of the laterally elongated miter rib and the length of the first member are the same.

5. The laterally elongated miter rib of claim 1 wherein the first length of the first arm and the second length of the second arm are the same.

6. The laterally elongated miter rib of claim 1 wherein the first arm and the second arm are formed from a single piece of material that is extruded.

7. The laterally elongated miter rib of claim 6 wherein the material is aluminum.

8. The laterally elongated miter rib of claim 1 wherein the first arm and the second arm are orthogonal to one another.

9. The laterally elongated miter rib of claim 1 wherein an angle subtended between the inward facing surface of the first arm and the second arm is an acute angle.

10. The laterally elongated miter rib of claim 1 wherein an angle subtended between the inward facing surface of the first arm and the second arm is an obtuse angle.

11. The laterally elongated miter rib of claim 1 wherein a ratio of the length of the laterally elongated miter rib to the first length of the first arm is at least 12:1.

12. The laterally elongated miter rib of claim 2 wherein the serrations are tapered in a forward direction.

13. The laterally elongated miter rib of claim 1 wherein the second end of the first arm and the second end of the second arm is rounded to ease insertion thereof into the slot in the respective first and second members.

14. The laterally elongated miter rib of claim 1 wherein the first length of the first arm is one inch and the second length of the second arm is one inch.

15. The laterally elongated miter rib of claim 14 wherein the length of the laterally elongated miter rib is at least 3 feet.

16. The laterally elongated miter rib of claim 14 wherein the length of the laterally elongated miter rib is at least 6 feet.

17. A laterally elongated miter rib for use in joining a first member and a second member to one another, the laterally elongated miter rib comprising aluminum, wherein the aluminum is extruded into a form characterized by:
(a) two arms of equal length;
(b) each of the arms comprising a surface modification that increases a grip between each arm and a respective slot in the first and second member in which the arms are disposed when the laterally elongated miter rib is in use;
(c) the arms are characterized by a lateral dimension that defines the length of the laterally elongated miter rib; and
(d) a ratio of the length of the laterally elongated miter rib to the length of the arm is at least 3:1.

18. The laterally elongated miter rib of claim 17 wherein the ratio is at least 12:1.

19. A laterally elongated miter rib for use in joining a first member and a second member to one another, the laterally elongated miter rib having a structure characterized as follows:
(a) two arms disposed substantially orthogonally to one another;
(b) each of the arms comprising a surface modification that increases a grip between each arm and a respective slot in the first and second member in which the arms are disposed when the laterally elongated miter rib is in use;
(c) the arms are characterized by a lateral dimension that defines the length of the laterally elongated miter rib; and
(d) a ratio of the length of the laterally elongated miter rib to the length of the arm is at least 3:1.

20. The laterally elongated miter rib of claim 19 comprising aluminum.
